(19) United States
(12) Patent Application Publication
(10) Pub. No.: US 2017/0305777 A1
(43) Pub. Date: Oct. 26, 2017

(54) VOLATILE FILTRATION SYSTEMS FOR FUSION DRAW MACHINES

(71) Applicant: CORNING INCORPORATED, CORNING, NY (US)

(72) Inventors: Benjamin Earl Black, Lancaster, KY (US); Tuan Quoc Nguyen, Danville, KY (US); Li Yang, Horseheads, NY (US)

(21) Appl. No.: 15/513,009

(22) PCT Filed: Sep. 22, 2015
(86) PCT No.: PCT/US15/51348

§ 371 Date: Mar. 21, 2017

Related U.S. Application Data
(60) Provisional application No. 62/054,531, filed on Sep. 24, 2014.

(51) Int. Cl. C03B 17/06; B01D 5/00; F23J 15/02; F23J 15/06

(52) U.S. Cl. CPC C03B 17/064; F23J 15/06; B01D 5/0027; F23J 15/022

(57) ABSTRACT

The disclosure relates to apparatuses for producing a glass ribbon, the apparatuses comprising a melting vessel, a forming vessel, and a volatile filtration system configured to receive at least a portion of a vapor comprising at least one volatilized component from the forming vessel, the volatile filtration system comprising a transfer vessel operating at a first temperature above a condensation point of the vapor and a quenching chamber operating at a second temperature below a solidification temperature of the volatilized component. Also disclosed herein are methods for producing a glass ribbon using such apparatuses and volatile filtration systems.

This application claims the benefit of priority to U.S. Application No. 62/054,531 filed Sep. 24, 2014 the content of which is incorporated herein by reference in its entirety.

### FIELD OF THE DISCLOSURE

The present disclosure relates generally to filtration systems for glass manufacturing systems, and more particularly to volatile filtration systems for fusion draw machines.

### BACKGROUND

High-performance display devices, such as liquid crystal displays (LCDs) and plasma displays, are commonly used in various electronics, such as cell phones, laptops, electronic tablets, televisions, and computer monitors. Currently marketed display devices can employ one or more high-precision glass sheets, for example, as substrates for electronic circuit components, or as color filters, to name a few applications. The leading technology for making such high-quality glass substrates is the fusion draw process, developed by Corning Incorporated, and described, e.g., in U.S. Pat. Nos. 3,338,696 and 3,682,609, which are incorporated herein by reference in their entireties.

The fusion draw process typically utilizes a fusion draw machine (FDM), which can comprise a forming body (e.g., isopipe). The forming body can comprise a trough and a lower portion having a wedge-shaped cross-section with two major side surfaces (or forming surfaces) sloping downwardly to join at a root. During operation, the trough is filled with molten glass, which is allowed to flow over the trough sides (or weirs) and down along the two forming surfaces as two glass ribbons, which ultimately converge at the root where they fuse together to form a unitary glass ribbon. The glass ribbon can thus have two pristine external surfaces that have not been exposed to the surface of the forming body. The ribbon can then be drawn down and cooled to form a glass sheet having a desired thickness and a pristine surface quality.

During the glass forming process, vapor volatilized from the surface of the molten glass can stay trapped in the FDM. The trapped vapor can eventually form a viscous liquid that can coat the internal walls of the FDM and, in many cases, can ooze or drip down within the system. Droplets of condensed vapors can adhere to the glass sheet, which can render the sheet defective. Additionally, the droplets can upset the glass ribbon by causing crackouts and/or rubicon formation if they fall on roll surfaces. The volatile vapors trapped within the FDM can also damage the equipment, resulting in significant production losses. The vapor can comprise various volatilized compounds, e.g., B₂O₃, SiO₂, Al₂O₃, and CaO, to name a few.

FDMs can employ a vapor filtration system (VFS) to extract trapped vapors from the FDM. Venting of vapors from the FDM, e.g., from the top of the muffle region of the FDM, has been attempted, but this method has suffered various drawbacks. For example, simply exhausting vapor out of the FDM does not take into consideration the need to balance the internal pressure of the FDM and compensate for the exhausted air. Changes in air flow and/or pressure can cause defects, e.g., inclusion defects, in the glass. These previous methods may also suffer from equipment clogging due to vapor condensation, which can result in poor reliability and negative impact on process performance.

Consumer demand for high-performance displays with ever growing size and image quality requirements drives the need for improved manufacturing processes for producing high-quality, high-precision glass sheets. Accordingly, it would be advantageous to provide methods and apparatuses for forming glass ribbons and sheets which can minimize glass defects, as well as reduce equipment damage and process instabilities, e.g., caused by volatile vapors trapped in the FDM. In various embodiments, the methods and apparatuses disclosed herein can minimize equipment clogging, as well as reducing disturbances in the air flow inside the FDM, which can prevent inclusion defects in the glass sheets.

### SUMMARY

The disclosure relates to methods for producing a glass ribbon, the methods comprising melting batch materials to form molten glass; processing the molten glass to form a glass ribbon, wherein the processing step produces a vapor comprising at least one volatilized component; venting at least a portion of the vapor, wherein the vapor is maintained at a first temperature above a condensation temperature of the vapor during venting; and rapidly cooling the vapor to a second temperature below a solidification temperature of the volatilized component.

Also disclosed herein are apparatuses for producing a glass ribbon, the apparatuses comprising a melting vessel, a forming vessel, and a volatile filtration system configured to receive at least a portion of a vapor comprising at least one volatilized component from the forming vessel, the volatile filtration system comprising a transfer vessel and a quenching chamber, wherein the transfer vessel operates at a first temperature above a condensation temperature of the vapor, and wherein the quenching chamber operates at a second temperature below a solidification temperature of the volatilized component.

In various embodiments, the vapor vented from the forming vessel can be rapidly quenched, e.g., using a compressed fluid stream such as compressed dry air. According to various aspects, rapidly quenching the vapor comprises cooling the vapor within a time period sufficient to convert at least a portion of the volatilized component into a substantially solid form, essentially bypassing or substantially bypassing the liquid phase. In certain embodiments, a recycle loop can be used to re-inject heated air into the forming vessel, which can minimize disturbance of the air flow within the forming vessel. According to further embodiments, the vapor can comprise at least one volatilized component chosen from B₂O₃, SiO₂, Al₂O₃, CaO, and the like.

Additional features and advantages of the disclosure will be set forth in the detailed description which follows, and in part will be readily apparent to those skilled in the art from that description or recognized by practicing the methods as described herein, including the detailed description which follows, the claims, as well as the appended drawings.

It is to be understood that both the foregoing general description and the following detailed description present various embodiments of the disclosure, and are intended to provide an overview or framework for understanding the nature and character of the claims. The accompanying drawings are included to provide a further understanding of the disclosure, and are incorporated into and constitute a part of this specification. The drawings illustrate various embodiments of the disclosure and together with the description serve to explain the principles and operations of the disclosure.

### BRIEF DESCRIPTION OF THE DRAWINGS

The following detailed description can be best understood when read in conjunction with the following drawings, where like structures are indicated with like reference numerals where possible and in which:

FIG. 1 is a schematic of an exemplary glass manufacturing system;

FIG. 2 is a schematic of a forming vessel equipped with a vapor filtration system according to aspects of the disclosure;

FIG. 3 is a process flow diagram for a vapor filtration system according to aspects of the disclosure;

FIG. 4 is a schematic of a vapor filtration system according to aspects of the disclosure;

FIG. 5 is a schematic of a quenching chamber according to aspects of the disclosure; and

FIG. 6 is a graph illustrating a vapor cooling curve achieved using a vapor filtration method according to the disclosure as compared to a vapor cooling curve achieved using a prior art method.

### DETAILED DESCRIPTION

Apparatuses

Disclosed herein are apparatuses for producing a glass ribbon, the apparatuses comprising a melting vessel, a forming vessel, and a volatile filtration system configured to receive at least a portion of a vapor comprising at least one volatilized component from the forming vessel, the volatile filtration system comprising a transfer vessel operating at a first temperature above a condensation temperature of the vapor and a quenching chamber operating at a second temperature below a solidification temperature of the volatilized component.

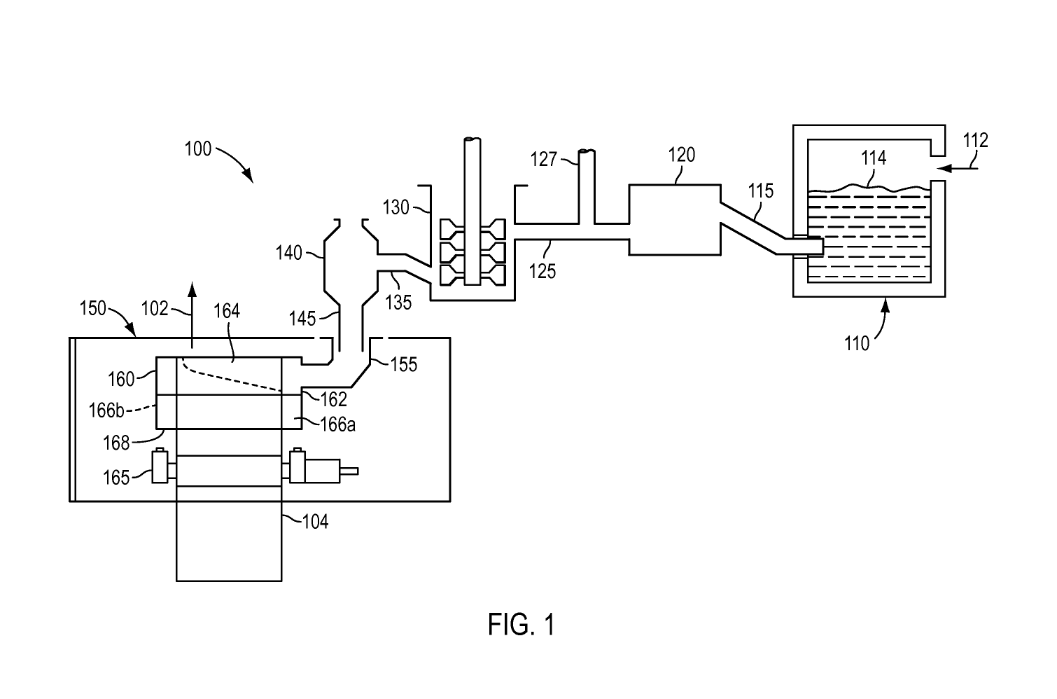

Embodiments of the disclosure will be discussed with reference to FIG. 1, which depicts an exemplary glass manufacturing system 100 for producing a glass ribbon 104. The glass manufacturing system 100 can include a melting vessel 110, a melting to fining tube 115, a fining vessel (e.g., finer tube) 120, a fining to stir chamber connecting tube 125 (with a level probe stand pipe 127 extending therefrom), a stir chamber (e.g., mixing vessel) 130, a stir chamber to bowl connecting tube 135, a bowl (e.g., delivery vessel) 140, a downcomer 145, and a FDM 150, which can include an inlet 155, a forming body (e.g., isopipe) 160, and a pull roll assembly 165.

Glass batch materials can be introduced into the melting vessel 110, as shown by arrow 112, to form molten glass 114. The fining vessel 120 is connected to the melting vessel 110 by the melting to fining tube 115. The fining vessel 120 can have a high temperature processing area that receives the molten glass from the melting vessel 110 and which can remove bubbles from the molten glass. The fining vessel 120 is connected to the stir chamber 130 by the fining to stir chamber connecting tube 125. The stir chamber 130 is connected to the bowl 140 by the stir chamber to bowl connecting tube 135. The bowl 140 can deliver the molten glass through the downcomer 145 into the FDM 150.

The FDM 150 can include an inlet 155, a forming body 160, and a pull roll assembly 165. The inlet 155 can receive the molten glass from the downcomer 145, from which it can flow to the forming body 160. The forming body 160 can include an opening 162 that receives the molten glass, which can flow into a trough 164, overflowing over the sides of the trough 164, and running down two opposing forming surfaces 166a and 166b before fusing together at a root 168 to form a glass ribbon 104. The pull roll assembly 165 can deliver the drawn glass ribbon 104 for further processing by additional optional apparatuses.

For example, the glass ribbon can be further processed by a traveling anvil machine (TAM), which can include a mechanical scoring device for scoring the glass ribbon. The scored glass can then be separated into pieces of glass sheet, machined, polished, chemically strengthened, and/or otherwise surface treated, e.g., etched, using various methods and devices known in the art. Of course, while the apparatuses and methods disclosed herein are discussed with reference to fusion draw processes and systems, it is to be understood that such apparatuses and methods can also be used in conjunction with other glass forming processes, such as slot-draw and float processes, to name a few.

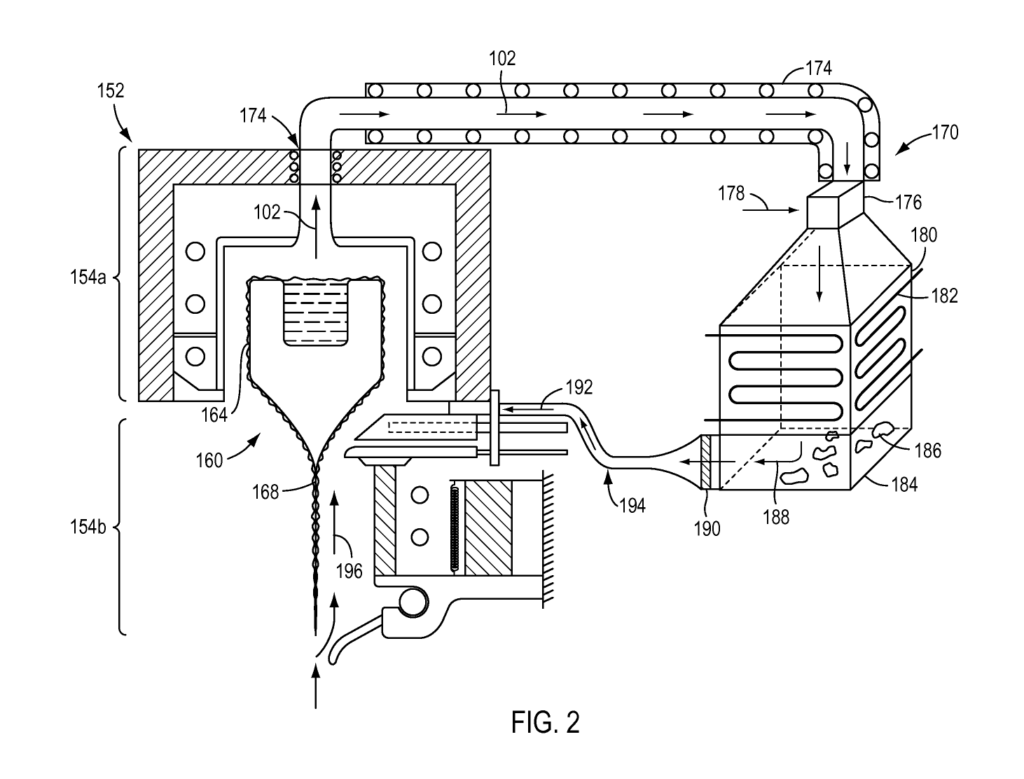

For example, during the glass ribbon forming process, e.g., in the FDM 150, volatilized compounds can form a vapor 102, which can become trapped inside the system, potentially causing damage to the glass ribbon and/or to the processing equipment. Accordingly, in certain aspects of the disclosure, a vapor filtration system (VFS) can be provided for venting vapors from the FDM, or forming vessel. FIG. 2 illustrates a portion of an FDM comprising a forming vessel 152, which includes a forming body 160, equipped with a VFS 170 according to non-limiting embodiments of the disclosure. A vapor stream 102 (illustrated as an arrow) can be vented from the forming vessel 152 by a transfer vessel (or duct) 172. The transfer vessel can be equipped with heating elements 174, which can maintain the temperature of the transfer vessel 172, and thus the vapor stream traveling therein, at a temperature above the condensation point of the vapor. In certain embodiments, the transfer vessel 172 can operate at a temperature similar or identical to a temperature within the forming vessel (e.g., a forming temperature).

By way of a non-limiting example, the forming vessel may operate at a temperature ranging, at its hottest point (e.g., at the upper portion 154a proximate the trough 164 of the forming body 160), from about 1100° C. to about 1300° C., such as from about 1150° C. to about 1250° C., from about 1150° C. to about 1225° C., or from about 1175° C. to about 1200° C., including all ranges and subranges therebetween. At its coolest point (e.g., the lower portion 154b proximate the root 168 of the forming body 160), the forming vessel may operate at a temperature ranging from about 800° C. to about 1150° C., such as from about 850° C. to about 1100° C., from about 900° C. to about 1050° C., or from about 950° C. to about 1000° C., including all ranges and subranges therebetween. The transfer vessel 172 can thus operate at a temperature above the condensation temperature of the vapor, such as a temperature at or near a forming temperature (e.g., a temperature at the hottest point in the forming vessel), this temperature ranging, for example, from about 1000° C. to about 1300° C., such as from about 1050° C. to about 1250° C., from about 1100° C. to about 1225° C., or from about 1150° C. to about 1200° C., including all ranges and subranges therebetween.

Vapor 102 traveling through the transfer vessel 172 can enter a quenching chamber 176, where it can be rapidly cooled to a temperature below the solidification point of a volatilized component in the vapor. For example, the vapor may be contacted with a compressed fluid stream 178, such as compressed dry air (CDA), dessicant air, or any suitable chilled gaseous stream, such as nitrogen, etc. Contact with the compressed fluid stream may serve to dilute the vapor stream and/or reduce the moisture content, and quickly cool the vapor such that the vapor can bypass or substantially bypass the liquid formation stage. The temperature and/or velocity of the compressed fluid stream 178 as it enters the quenching chamber 176 can vary and be controlled as a function of, e.g., the temperature, composition and/or velocity of the vapor stream as well as the dimensions of the quenching chamber 176.

According to various embodiments, the compressed fluid stream 178 can have a temperature ranging from about 0° C. to about −150° C., from about −20° C. to about −100° C., from about −30° C. to about −60° C., or from about −40° C. to about −50° C., including all ranges and subranges therebetween. In one exemplary non-limiting embodiment, the compressed fluid stream can have a temperature ranging from about −35° C. to about −40° C. The velocity of the compressed fluid stream may range for example, from about 0.5 m/sec to about 2000 m/sec, such as from about 1 m/sec to about 1000 m/sec, from about 2 m/sec to about 100 m/sec, from about 5 m/sec to about 20 m/sec, or from about 5 m/sec to about 15 m/sec, including all ranges and subranges therebetween. It is within the ability of one skilled in the art to select the stream velocity appropriate for the desired operation and result.

The vapor stream 102 can thus be rapidly cooled to a temperature below the solidification point of a volatilized component in the vapor, e.g., a temperature less than about 600° C., such as less than about 575° C., less than about 550° C., less than about 525° C., or less than about 500° C. In certain embodiments, the vapor stream can be rapidly cooled to a temperature ranging from about 200° C. to about 600° C., from about 250° C. to about 500° C., or from about 300° C. to about 400° C., including all ranges and subranges therebetween.

According to various embodiments, the term “rapid cooling” and variations thereof is used to denote cooling of the vapor to at least the solidification temperature of a volatilized component present in the vapor within a period of time sufficient to bypass or substantially bypass the liquid phase. According to various embodiments, the time period may be less than about 10 seconds, for instance, less than about 5 seconds, less than about 1 second, less than about 0.5 seconds, or less than about 0.1 seconds, although longer or shorter time periods are possible and intended to fall within the scope of the disclosure. In other embodiments, the rapid cooling may occur within milliseconds, for example, the time period may range from about 0.01 to about 0.09 seconds. Without wishing to be bound by theory, it is believed that rapid cooling of the vapor as disclosed herein may minimize or eliminate the presence of liquid components in the processing equipment, thereby reducing the associated hazards, such as corrosion and/or clogging.

The cooled vapor stream 102 (including any solid particulates) can then travel to one or more condensers 180, which can be equipped with one or more cooling elements 182, for example, a water-cooled condenser equipped with a cooling coil. The vapor stream 102 can be further cooled in the condenser 180, which can precipitate additional components from the vapor stream 102, for example, moisture in the vapor stream can be condensed, as well as other components having lower solidification points or condensation points. The at least one condenser 180 can, for example, cool the vapor stream to a temperature ranging from about 100° C. to about 500° C., such as from about 150° C. to about 400° C., from about 200° C. to about 350° C., or from about 250° C. to about 300° C., including all ranges and subranges therebetween. In one non-limiting embodiment, the VFS can include a first condenser that can cool the vapor stream from a first temperature ranging from about 500° C. to about 600° C. to a second temperature ranging from about 250° C. to about 450° C., such as from about 300° C. to about 400° C., including all ranges and subranges therebetween. The VFS can further include a second condenser that can cool the vapor stream down to a third temperature ranging from about 100° C. to about 200° C., such as from about 110° C. to about 180° C., from about 120° C. to about 170° C., from about 130° C. to about 160° C., or from about 140° C. to about 150° C., including all ranges and subranges therebetween.

The condenser 180 can be equipped with a collecting compartment 184, or a collecting compartment can be provided as a separate component of the VFS. Solid particles and/or liquids from the condenser 180 can amass in the collecting compartment 184 as a separated solid component 186. A separated gaseous component (e.g., gas stream) 188 can then be passed through an air filter 190, and the resulting filtered air 192 can then be heated and recycled back to the forming vessel 152 via a recycle loop 194, in some embodiments. The filtered air 192 can, in certain embodiments, be used to supplement the depleted air flow 196 within the forming vessel as a “make-up” stream.

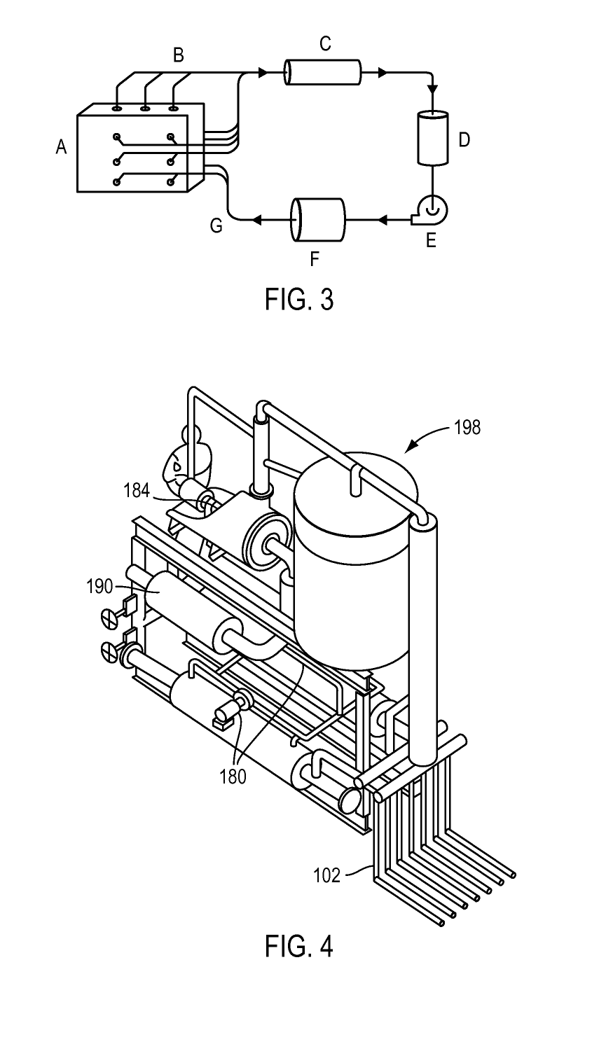

FIG. 3 illustrates an exemplary flow diagram for a VFS according to various embodiments of the disclosure. While FIGS. 1 and 2 illustrated the vapor stream as exiting from the top, e.g., muffle region, of the forming vessel, it is to be understood that venting at any point in the vessel or FDM is possible. For example, as illustrated in FIG. 3, the forming vessel can include several venting points, e.g., from the top and/or sides or any other suitable location, such as at the muffle or transition regions (see, e.g., 154a and 154b, respectively in FIG. 2), at which vapor can be exhausted from the vessel. In step A, the vapor can be vented from the forming vessel and heated in step B to maintain the vapor at a temperature above its condensation temperature. The vapor can then be quenched and cooled in step C to solidify at least one volatilized component and/or to condense various components present in the vapor stream. A particulate filter can be used in step D to separate any solid particles from the gas stream. The filtered stream can then be transported, e.g., by way of a blower, in step E, to an optional heating unit. The filtered stream can then be heated in step F, and recycled back to the forming vessel in step G, in some embodiments.

FIG. 4 is a schematic depicting a non-limiting embodiment of VFS equipment that can be used to carry out the methods disclosed herein, e.g., the method described in the flow diagram of FIG. 3. In the illustrated embodiment, a vapor stream 102 from the forming vessel can be heated and transported to a quenching chamber 176, where it can be rapidly cooled, e.g., by contacting one or more compressed streams (not shown). The vapor stream can then flow through at least one condenser 180 (two shown) for further cooling. Any solid particles and/or condensed liquids can be collected in a collecting compartment 184, e.g., a dust collector. The remaining separated gas stream can then be filtered (not shown) and heated in a heating unit 198. The heated gas stream can then be recycled back to the forming vessel as a make-up stream (not shown), according to some embodiments.

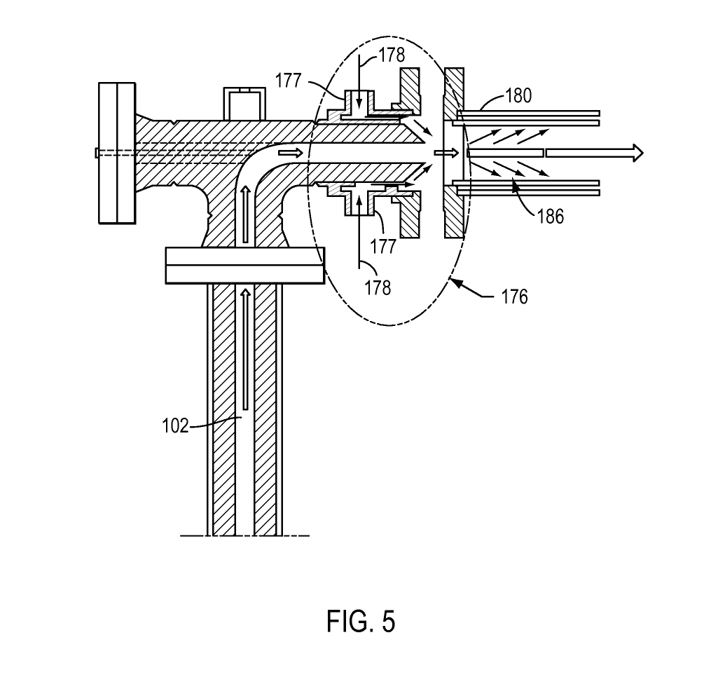

FIG. 5 provides a more detailed perspective of a quenching chamber according to various aspects of the disclosure. As can be seen in the figure, the quenching chamber 176 can, in some embodiments, be a valve coupled to the at least one condenser 180. A heated vapor stream 102 can flow through the quenching chamber, which can comprise one or more inlets 177, through which a compressed fluid stream can flow into the chamber to contact the vapor stream 102. The combined streams can then flow into the condenser 180 for further cooling. As the vapor stream enters the condenser, the separated solid component 186 (e.g., solidified particulates) may begin dropping out of the gaseous vapor, e.g., due to gravitational forces, and can be collected in the collecting vessel.

The terms “vapor stream” and “vapor” are used interchangeably herein to refer to the stream(s) vented from the forming vessel and subsequently heated, quenched, and cooled. The vapor stream comprises at least one volatilized component which can be in gaseous form in the forming vessel and the transfer vessel, and in substantially solid or particulate form upon exiting the quench chamber. The vapor stream as described herein is understood to encompass both the gaseous vapor and any particulate matter entrained therein.

As used herein, the term “solidification temperature” and variations thereof are intended to denote a temperature at which at least one gas to solid transformation results in a substantially liquid-free bulk vapor comprising at least one solid particulate, e.g., substantially solid particulates entrained in the bulk vapor, wherein the gas to solid transformation is associated with a decrease in temperature. The solidification temperature can also be referred to as the deposition temperature, or the temperature at which at least a portion of the vapor transforms into a solid, e.g., the opposite of sublimation. Similarly, the term “condensation temperature” and variations thereof are intended to denote a temperature at which at least one gas to liquid transformation results in the introduction of at least one liquid phase in the bulk vapor, wherein the gas to liquid transformation is associated with a decrease in temperature.

As used herein, the term “substantially solid” and variations thereof are intended to denote a formerly volatilized component that is converted essentially or totally into solid particles. For instance, the solid particles may comprise 100% by weight of solids or, in other embodiments, the solid particles may comprise greater than about 99.9% by weight of solids, such as greater than about 99.5%, greater than about 99%, greater than about 98%, greater than about 97%, greater than about 96%, or greater than about 95% by weight of solids.

By way of a non-limiting example, the vapor stream can comprise at least one volatilized component, such as B₂O₃, SiO₂, Al₂O₃, and CaO, to name a few. Boron, e.g., in the form of B₂O₃, can be volatilized during the forming process to form gaseous B₂O₃. Using boron as a non-limiting example, the vapor stream can be vented from the forming vessel and maintained at a temperature above the condensation temperature of the vapor. For instance, the vapor stream can be heated and maintained at a temperature above about 1000° C., such as above about 1100° C., or above about 1200° C., for example, ranging from about 1000° C. to about 1300° C., such as from about 1050° C. to about 1250° C., from about 1100° C. to about 1225° C., or from about 1150° C. to about 1200° C., including all ranges and subranges therebetween. Maintaining the vapor above the condensation temperature can, in various embodiments, prevent the formation of liquids in the processing equipment, which could otherwise damage the various equipment parts and/or potentially clog the equipment.

In the quench chamber, the vapor stream can be contacted with a compressed fluid stream, such as a dry compressed stream, e.g., CDA. The dry, cool air can reduce the moisture content of the vapor stream and/or dilute the stream, thereby rapidly cooling the vapor stream to a temperature below the solidification temperature of the volatilized component (e.g., B₂O₃) so as to bypass or substantially bypass the formation of a liquid phase. In the case of boron vaporized as B₂O₃, the solidification point is estimated at about 557° C. Thus, rapidly cooling the vapor to a temperature below about 550° C. should, in various embodiments, result in a solid particulate comprising boron without the formation of, or substantially without the formation of, a liquid phase. As opposed to a liquid condensate, which may clog the equipment, a substantially dry, solid particulate may be more easily filtered out of the system, e.g., by way of an air filter and/or dust collector. Of course, the example of B₂O₃ as a volatilized component should not limit the scope of the claims appended herewith as exemplary embodiments can be used to remove any number of volatilized components.

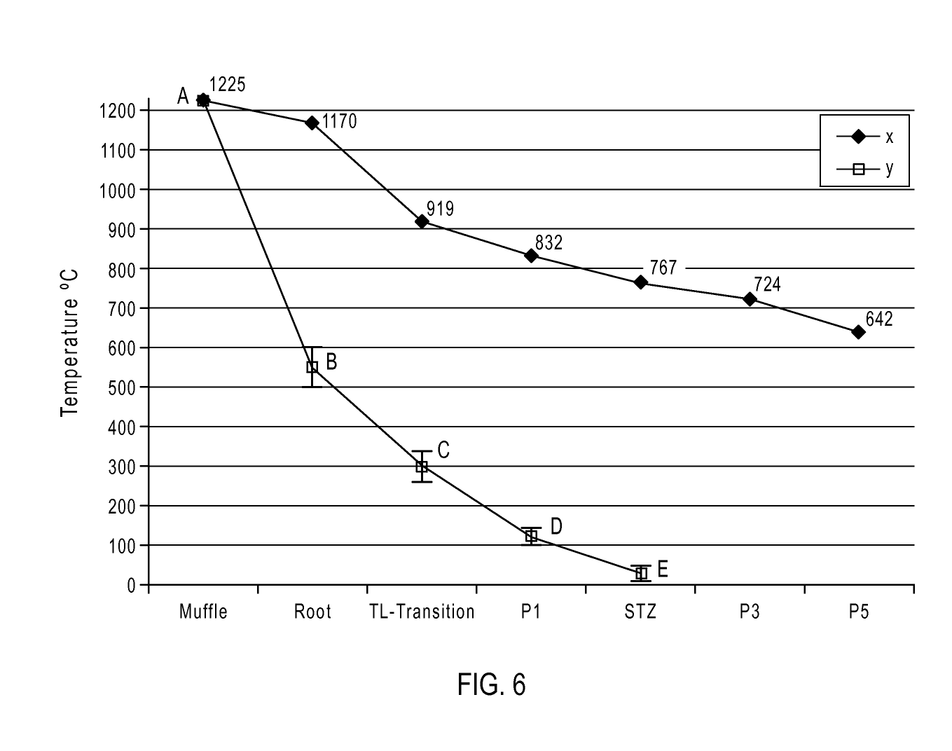

FIG. 6 illustrates an exemplary cooling curve Y that can be achieved according to various aspects of the disclosure for an exemplary volatilized boron vapor. A prior art cooling curve X is also included for purposes of comparison. Using the methods and apparatuses disclosed herein, a vapor comprising volatilized boron exiting the muffle at stage A (at about 1225° C.) can be rapidly cooled at stage B in the quenching chamber (to about 500-600° C.), cooled in a first condenser at stage C (to about 275-325° C.), further cooled in a second condenser at stage D (to about 100-140° C.) and, upon exit from the VFS at stage E, e.g., after filtration, can have a final temperature of about 25-40° C. Of course, as discussed above, the VFS can, in certain embodiments, also include a heating unit for re-heating the vapor to a temperature suitable for recycle back into the formation vessel.

In contrast, using prior art methods, the volatilized boron vapor cools more gradually in several steps, during which liquid formation is possible, thereby posing a risk of clogging the equipment. For instance, cooling curve X depicts temperature measurements made along various points in the draw using thermocouple or pyro temperature sensors to measure glass ribbon temperature for a 79″ E×G system without VFS. As illustrated by the curve X, without venting, any volatilized boron vapor cannot reach a temperature below the solidification point for the volatilized boron, thus remaining in a liquid-gas state which can make the process stream more difficult to transport and/or the equipment harder to clean. Accordingly, FIG. 6 demonstrates that using the methods and apparatuses disclosed herein, it is possible to rapidly cool a vapor comprising at least one volatilized component such that the liquid phase is substantially avoided while also producing a solid particulate phase which can be more easily transported and cleaned from the system.

Methods

Disclosed herein are methods for producing a glass ribbon, the methods comprising melting batch materials to form molten glass; processing the molten glass to form a glass ribbon, wherein the processing step produces a vapor comprising at least one volatilized component; venting at least a portion of the vapor, wherein the vapor is maintained at a first temperature above a condensation temperature of the vapor during venting; and rapidly cooling the vapor to a second temperature below a solidification temperature of the volatilized component.

The term “batch materials” and variations thereof is used herein to denote a mixture of glass precursor components which, upon melting, react and/or combine to form a glass. The glass batch materials may be prepared and/or mixed by any known method for combining glass precursor materials. For example, in certain non-limiting embodiments, the glass batch materials can comprise a dry or substantially dry mixture of glass precursor particles, e.g., without any solvent or liquid. In other embodiments, the glass batch materials may be in the form of a slurry, for example, a mixture of glass precursor particles in the presence of a liquid or solvent.

According to various embodiments, the batch materials may comprise glass precursor materials, such as silica, alumina, and various additional oxides, such as boron, magnesium, calcium, sodium, strontium, tin, or titanium oxides. For instance, the glass batch materials may comprise a mixture of silica and/or alumina with one or more additional oxides. In various embodiments, the glass batch materials can comprise from about 45 to about 95 wt % collectively of alumina and/or silica and from about 5 to about 55 wt % collectively of at least one oxide of boron, magnesium, calcium, sodium, strontium, tin, and/or titanium.

The batch materials can be melted according to any method known in the art, including the methods discussed herein with reference to FIG. 1. For example, the batch materials can be added to a melting vessel and heated to a temperature ranging from about 1100° C. to about 1700° C., such as from about 1200° C. to about 1650° C., from about 1250° C. to about 1600° C., from about 1300° C. to about 1550° C., from about 1350° C. to about 1500° C., or from about 1400° C. to about 1450° C., including all ranges and subranges therebetween. The batch materials may, in certain embodiments, have a residence time in the melting vessel ranging from several minutes to several hours, depending on various variables, such as the operating temperature and the batch size. For example, the residence time may range from about 30 minutes to about 8 hours, from about 1 hour to about 6 hours, from about 2 hours to about 5 hours, or from about 3 hours to about 4 hours, including all ranges and subranges therebetween.

The molten glass can subsequently undergo various additional processing steps, including fining to remove bubbles, and stirring to homogenize the glass melt, to name a few. The molten glass can then be processed to produce a glass ribbon according to any method known in the art, including the fusion draw methods discussed herein with reference to FIGS. 1-2, as well as slot-draw and float methods. Vapors created during the processing step can be vented and cooled using a VFS as described herein.

In certain embodiments, one or more vapor streams can be vented from a forming vessel, e.g., by natural convection and/or air pull induced by a fan. Reference made herein to a venting step is intended to refer, e.g., to the extraction of the vapor from the forming vessel and its transportation away from the forming vessel to a cooling unit, e.g., a quenching chamber and/or condenser. According to various aspects of the disclosure, during the venting step the vapor stream is maintained at a first temperature above the condensation point of the vapor. The first temperature can be maintained, for instance, by heating the transfer vessel through which the vapor stream travels from the forming vessel to the quenching chamber. By way of a non-limiting example, the transfer vessel can operate at a temperature ranging from about 1000° C. to about 1200° C., such as from about 1050° C. to about 1175° C., or from about 1100° C. to about 1150° C., including all ranges and subranges therebetween.

The vapor stream can then enter a quenching chamber where it can be rapidly cooled to a second temperature below a solidification point of at least one volatilized component in the vapor stream. The velocity and/or volumetric flow rate of the vapor stream can vary depending on various processing parameters, for example, as a function of the heat transfer necessary to rapidly cool the vapor stream, e.g., to solidify the volatilized component of interest. It is within the ability of one skilled in the art to select an appropriate vapor flow rate and/or velocity depending on the desired application.

As discussed herein with respect to the apparatuses, the vapor stream can be quenched to a first temperature and subsequently cooled by one or more condensers to a second temperature, or even a third temperature. After quenching and cooling, the vapor stream can undergo various separation processes, to separate any solid particulates or liquid condensates from the gas stream. The separated solid component can be discarded, analyzed, or otherwise recycled for another purpose. The separated gaseous component can be filtered, e.g., using an air filter and heated to a temperature suitable for optional recycle back into the forming vessel. For instance, the filtered air can be heated to a temperature ranging from about 1000° C. to about 1250° C., such as from about 1050° C. to about 1200° C., or from about 1100° C. to about 1150° C., including all ranges and subranges therebetween.

The methods and apparatuses disclosed herein may provide one or more advantages over prior art filtration systems and/or FDMs operating without a filtration system. In certain embodiments, the rapid cooling of the vapor stream allows for the bypass or substantial bypass of the potentially problematic liquid condensation phase within the FDM. Moreover, the VFS disclosed herein can reduce condensation build-up in the FDM by removing the source of the condensation (e.g., the volatile vapors). The reduction of condensation within the FDM can result in a reduction in cracks in the glass, rubicon formation, process instability, and/or production losses related to condensation. For example, by reducing condensation, the degradation or “dissolving” of refractory materials in the muffle region due to vapor attack can be reduced or even eliminated. The risk for equipment failure due to the presence of condensate can also be reduced, such that equipment life and performance is enhanced over time. Furthermore, the glass sheet quality can be improved due to the reduction or absence of condensation defects. The projected cost savings for a glass manufacturing process employing a VFS as disclosed herein can be as high as 100 million dollars.

In addition, because the VFS system is external to the FDM, it can be easily retrofitted, turned on and off, cleaned, and/or tuned without major upsets to the FDM. Further, the VFS can be adjusted, monitored, and controlled with basic industrial metrology and control systems. The lack of specialized materials and/or parts in the VFS can provide a significant cost savings as compared to other filtration systems. Finally, the VFS disclosed herein can allow for the collection of particulate samples for analysis, as well as improved ease of cleaning and maintenance. Periodic cleaning of the VFS can be carried out using standard tools and techniques common in the glass industry, thus minimizing complexity, down time, and/or cost. Of course, it is to be understood that the methods and apparatuses disclosed herein may not have one or more of the above advantages, but such methods and apparatuses are intended to fall within the scope of the appended claims.

It will be appreciated that the various disclosed embodiments may involve particular features, elements or steps that are described in connection with that particular embodiment. It will also be appreciated that a particular feature, element or step, although described in relation to one particular embodiment, may be interchanged or combined with alternate embodiments in various non-illustrated combinations or permutations.

It is also to be understood that, as used herein the terms “the,” “a,” or “an,” mean “at least one,” and should not be limited to “only one” unless explicitly indicated to the contrary. Thus, for example, reference to “a condenser” includes examples having two or more such condensers unless the context clearly indicates otherwise.

Ranges can be expressed herein as from “about” one particular value, and/or to “about” another particular value. When such a range is expressed, examples include from the one particular value and/or to the other particular value. Similarly, when values are expressed as approximations, by use of the antecedent “about,” it will be understood that the particular value forms another aspect. It will be further understood that the endpoints of each of the ranges are significant both in relation to the other endpoint, and independently of the other endpoint.

The terms “substantial,” “substantially,” and variations thereof as used herein are intended to note that a described feature is equal or approximately equal to a value or description. Moreover, “substantially similar” is intended to denote that two values are equal or approximately equal. In some embodiments, “substantially similar” may denote values within about 10% of each other, such as within about 5% of each other, or within about 2% of each other.

Unless otherwise expressly stated, it is in no way intended that any method set forth herein be construed as requiring that its steps be performed in a specific order. Accordingly, where a method claim does not actually recite an order to be followed by its steps or it is not otherwise specifically stated in the claims or descriptions that the steps are to be limited to a specific order, it is no way intended that any particular order be inferred.

While various features, elements or steps of particular embodiments may be disclosed using the transitional phrase “comprising,” it is to be understood that alternative embodiments, including those that may be described using the transitional phrases “consisting” or “consisting essentially of,” are implied. Thus, for example, implied alternative embodiments to a system that comprises A+B+C include embodiments where a system consists of A+B+C and embodiments where a system consists essentially of A+B+C.

It will be apparent to those skilled in the art that various modifications and variations can be made to the present disclosure without departing from the spirit and scope of the disclosure. Since modifications combinations, sub-combinations and variations of the disclosed embodiments incorporating the spirit and substance of the disclosure may occur to persons skilled in the art, the disclosure should be construed to include everything within the scope of the appended claims and their equivalents.

What is claimed is:

1. A method for producing a glass ribbon, comprising:
melting batch materials to form molten glass;
processing the molten glass to form a glass ribbon, wherein the processing step produces a vapor comprising at least one volatilized component;
venting at least a portion of the vapor, wherein the vapor is maintained at a first temperature above a condensation temperature of the vapor during venting; and
rapidly cooling the vapor to a second temperature below a solidification temperature of the volatilized component.

2. The method of claim 1, wherein rapid cooling comprises contacting the vapor with at least one compressed fluid stream chosen from compressed dry air, dessicant air, or liquid nitrogen.

3. The method of claim 1, wherein rapid cooling occurs within a time period of about 10 seconds or less.

4. The method of claim 1, wherein the processing step is carried out in a fluid draw machine comprising an isopipe.

5. The method of claim 1, wherein the at least one volatilized component is chosen from B₂O₃, SiO₂, Al₂O₃, CaO, and combinations thereof.

6. The method of claim 1, wherein the first temperature ranges from about 1000° C. to about 1300° C.

7. The method of claim 1, wherein the second temperature is less than about 600° C.

8. The method of claim 1, further comprising cooling the vapor to a third temperature ranging from about 100° C. to about 300° C.

9. The method of claim 1, wherein after the rapid cooling step the vapor is substantially liquid-free.

10. The method of claim 1, further comprising separating the vapor into a gaseous component and a solid component.

11. The method of claim 10, further comprising filtering, heating, and recycling the gaseous component for use in the processing step.

12. An apparatus for forming a glass ribbon, comprising:
a melting vessel;
a forming vessel; and
a volatile filtration system configured to receive at least a portion of a vapor comprising at least one volatilized component from the forming vessel, the volatile filtration system comprising:
a transfer vessel operating at a first temperature above a condensation temperature of the volatile vapor; and
a quenching chamber operating at a second temperature below a solidification temperature of the volatilized component.

13. The apparatus of claim 12, wherein the forming vessel comprises an isopipe.

14. The apparatus of claim 12, wherein the first temperature ranges from about 1000° C. to about 1300° C.

15. The apparatus of claim 12, wherein the quenching chamber comprises at least one inlet configured to deliver a compressed fluid stream into the quenching chamber.

16. The apparatus of claim 12, wherein the second temperature is less than about 600° C.

17. The apparatus of claim 12, further comprising at least one condenser operating at a temperature ranging from about 100° C. to about 300° C.

18. The apparatus of claim 12, further comprising a filter for separating a solid component from the vapor.

19. The apparatus of claim 12, further comprising a recycle loop for returning a gaseous portion of the vapor to the forming vessel, and a heating unit for heating the gaseous portion of the vapor prior to recycle.

20. The apparatus of claim 12, wherein the at least one volatilized component is chosen from B₂O₃, SiO₂, Al₂O₃, CaO, and combinations thereof.
